(19) United States
(12) Patent Application Publication
(10) Pub. No.: US 2013/0129244 A1
(43) Pub. Date: May 23, 2013

(54) Method for coding of stereoscopic depth

(71) Applicant: Poznan University of Technology, Poznan (PL)

(72) Inventors: Marek DOMANSKI, Poznan (PL); Tomasz Grajek, Poznan (PL); Jacek Konieczny, Poznan (PL); Maciej Kurc, Poznan (PL); Adam Luczak, Poznan (PL); Jakub Siast, Skwierzyna (PL); Olgierd Stankiewicz, Poznan (PL); Jakub Stankowski, Poznan (PL); Krzysztof Wegner, Murowana Goslina (PL)

(73) Assignee: Poznan University of Technology, Poznan (PL)

(21) Appl. No.: 13/680,822

(22) Filed: Nov. 19, 2012

(30) Foreign Application Priority Data
Nov. 17, 2011 (PL) P.397016

(51) Int. Cl. H04N 7/30

(52) U.S. Cl. CPC H04N 7/30
USPC 382/244; 382/248

(57) ABSTRACT

A method for coding a stereoscopic depth. The method includes encoding a signal varied in a non-linear relation to the stereoscopic depth so as to obtain a transformed signal, and decoding the transformed signal using an inverse non-linear transformation so as to reconstruct the stereoscopic depth. The dynamics of the transformed signal for small values of the stereoscopic depth are greater than the dynamics of the transformed signal for large values of the stereoscopic depth.

### CROSS-REFERENCE TO RELATED APPLICATIONS

This application claims priority to Polish Patent Application No. P.397016, filed Nov. 17, 2011, the entire contents of which are hereby incorporated by reference.

### BACKGROUND

The object of the invention is a method for coding of stereoscopic depth, applicable to both depth maps and disparity maps, in form of still pictures as well as moving video sequences.

The idea of a depth map is known in the literature and understood as an image that directly represents the depth of the scene or the normalized disparity. See, e.g., Domanski “Obraz cyfrowy” Wydawnictwo Kominikacji i Lacznosci, issue 1, Warszawa 2010; and ISO/IEC JTC1/SC29/WG11, “Report on Experimental Framework for 3D Video Coding”, Doc. N11631, Guangzhou, China, October 2010.

Lossy and lossless compression methods for both still pictures and moving video sequences are known in the literature, such as MPEG-4 AVC/H.264, described in “ISO/IEC 14496-10:2010. Information technology—Coding of audio-visual objects—Part 10: Advanced Video Coding”. Such methods, apart from generic usage for compression of images of natural scenes, are frequently used for compression of depth maps. Moreover, modifications and extensions of such technologies, specialized for compression of depth, are also known, such as MPEG-C part 3, described in ISO/IEC 23002-3 and in A. Bourge, J. Gobert, F. Bruls, “MPEG-C Part 3: Enabling the introduction of video plus depth contents,” Content generation and coding for 3D-television workshop, 2006. Platelet coding technology is described in K. Muller, P. Merkle, G. Tech, T. Wiegand, “3D VIDEO FORMATS AND CODING METHODS”, 17th IEEE International Conference on Image Processing (ICIP), 2010. Other techniques are described in B. -B. Chai, S. Sethuraman, H. S. Sawhney, “A depth map representation for real-time transmission and view-based rendering of a dynamic 3D scene,” 3D Data Processing Visualization and Transmission, 2002. Proceedings. First International Symposium on, pages 107-114, 2002; and in D. Tzovaras, N. Grammalidisi, M. G. Strintzis, “Disparity field and depth map coding for multiview 3D image generation Image Communication”, Vol. 11, No. 3, 1998.

Compression techniques known from the literature do not exploit the method according to the present invention.

Nonlinear depth transformation of depth is known in the literature. See, e.g., T. Senoh, K. Yamamoto, R. Oi, Y. Ichihashi, T. Kurita, “Proposal on non-linear normalization of Depth maps to 8 bits”, ISO/IEC m21189, Torino, Italy, 2011. This, however, has a different character, i.e., contrary to the transformation according to the present invention. Additionally, the field of application thereof—improvement of subjective quality of synthesis—is different than that of the present invention, which applies to compression and coding.

Also known is the concept of companding, which is a method of transmitting, in a transmission channel, a signal that is non-linearly dependent on the source signal, while, on the receiver's side, the reconstruction of the source signal is attained by a non-linear transformation, inverse to the one used on the transmitter's side. See, e.g., A. B. Clark “Electrical picture-transmitting system”, U.S. Pat. No. 1,691,147, 1928. Companding is also used in natural video (gamma correction), and audio and speech (μ-law, A-law) transmission systems, which are described in the ITU-T G.711 recommendation.

The techniques known in the literature do not disclose the method for coding a depth map according to the present invention.

Efficient coding of depth information still remains an unresolved technical problem. The techniques known in the literature do not employ the method according to the present invention.

### SUMMARY

The essence of the present invention is a method for coding of a stereoscopic depth, which includes coding a signal varied in a non-linear relation to the stereoscopic depth, wherein the dynamics of the transmitted signal for small values of the stereoscopic depth are greater than those for large values of the stereoscopic depth, and, wherein, at the receiving end, during decoding, the stereoscopic depth is reconstructed using an inverse non-linear transformation.

Application of the method according to the invention achieves the following technical and economical effects: an increase of the compression ratio for video sequences with depth information; an increase of the compression ratio for depth maps; and enhancement of the quality of synthesized virtual views.

### BRIEF DESCRIPTION OF THE FIGURES

FIG. 1 shows an exemplary scheme of a coding and decoding system for a video sequence with depth information.

FIG. 2 shows diagrams of exemplary nonlinear transformations.

### DETAILED DESCRIPTION

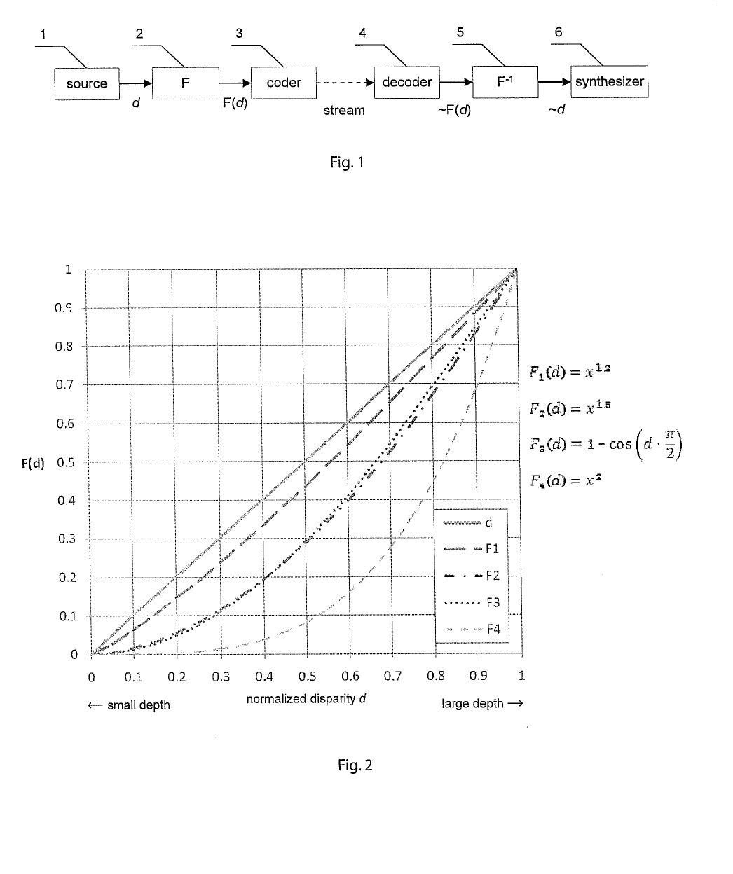

The invention can be illustrated by the following exemplary embodiment and with reference to FIGS. 1-2.

A stereoscopic depth map in a form of a normalized disparity map d may be retrieved from a source 1, such as an acquisition system or a depth estimation module. Subsequently, in a first module 2, the map d can be processed using a nonlinear transformation F in order to obtain a signal F(d). The nonlinear transformation F, examples of which are shown in FIG. 2, can have greater dynamics for small stereoscopic depth values than for large stereoscopic depth values.

The signal F(d) signal can then be lossy coded in a coder 3 and transmitted to a decoder 4, yielding a decoded reconstructed signal ˜F(d). So as to retrieve the disparity information, the decoded reconstructed signal ˜F(d) can then be processed in a second module 5 by a nonlinear transformation F⁻¹, which can be inverse to F. The reconstructed stereoscopic depth signal ˜d can then be used for synthesis of virtual views in a synthesizer 6.

By the application of the nonlinear transformation method according to the present invention, the dynamics of the coded signal can depend on the values of stereoscopic depth, such that the distortion introduced by lossy coding can be focused in distant regions, which can be represented by large values of stereoscopic depth. This can allow for obtaining a higher quality of the reconstructed signal, relative to coding and decoding systems for video sequences with depth information in which the present invention is not applied.

The foregoing exemplary detailed description of the successive steps of coding and decoding of stereoscopic depth according to the invention should not be interpreted as a limitation of the idea of the invention. One skilled in the art of computer graphics, compression and coding, can recognize that the described exemplary technique can be modified, adapted or implemented differently, without departing from its technical character and without diminishing the technical effects attained. Therefore, the above-disclosed description should not be interpreted as limited to the disclosed exemplary embodiments nor as defining variants of the stereoscopic depth coding in the patent claims.

What is claimed is:

1. A method for coding a stereoscopic depth, comprising:
encoding a signal varied in a non-linear relation to the stereoscopic depth so as to obtain a transformed signal; and
decoding the transformed signal using an inverse non-linear transformation so as to reconstruct the stereoscopic depth;
wherein the dynamics of the transformed signal for small values of the stereoscopic depth are greater than the dynamics of the transformed signal for large values of the stereoscopic depth.

2. The method of claim 1, wherein encoding the signal further comprises transforming the signal using a non-linear transformation.

3. The method of claim 2, wherein the inverse non-linear transformation is inverse to the non-linear transformation.

4. The method of claim 1, further comprising:
lossy-encoding the transformed signal to obtain a lossy-coded signal; and
decoding the lossy-coded signal to reconstruct the transformed signal.

5. The method of claim 4, further comprising transmitting the lossy-coded signal.

6. A method for encoding a stereoscopic depth, comprising:
encoding a signal varied in a non-linear relation to the stereoscopic depth so as to obtain a transformed signal;
wherein the dynamics of the transformed signal for small values of the stereoscopic depth are greater than the dynamics of the transformed signal for large values of the stereoscopic depth.

7. The method of claim 6, wherein encoding the signal further comprises transforming the signal using a non-linear transformation.

8. The method of claim 6, further comprising lossy-encoding the transformed signal to obtain a lossy-coded signal.

9. The method of claim 8, further comprising transmitting the lossy-coded signal.

10. A method for decoding a stereoscopic depth, comprising:
decoding a signal using an inverse non-linear transformation so as to reconstruct a stereoscopic depth;
wherein the dynamics of the signal for small values of the stereoscopic depth are greater than the dynamics of the signal for large values of the stereoscopic depth.

11. The method of claim 10, further comprising receiving a lossy-coded signal.

12. The method of claim 11, further comprising decoding the lossy-coded signal to reconstruct the signal.

13. The method of claim 10, wherein the inverse non-linear transformation is inverse to a non-linear transformation used to obtain the signal.
